(19) United States
(12) Patent Application Publication
(10) Pub. No.: US 2020/0175148 A1
(43) Pub. Date: Jun. 4, 2020

(54) COLLABORATIVE CONTEXT-AWARE VISUAL AUTHENTICATION QUESTION PROTOCOL

(71) Applicant: GEORGE MASON UNIVERSITY, Fairfax, VA (US)

(72) Inventors: Andeep Singh TOOR, Mountainview, CA (US); Harry WECHSLER, Fairfax, VA (US)

(21) Appl. No.: 16/701,600

(22) Filed: Dec. 3, 2019

Related U.S. Application Data
(60) Provisional application No. 62/775,118, filed on Dec. 4, 2018.
(60) Provisional application No. 62/793,256, filed on Jan. 16, 2019.

(51) Int. Cl. G06F 21/36; H04L 29/06; G06F 3/0482

(52) U.S. Cl. CPC G06F 21/36; G06F 3/0482; H04L 67/42

(57) ABSTRACT

A system for improved personal authentication using a combination of pictures and text passwords that gets more secure over time as more users utilize the system. The system increases the security of authentication by using methods that are easier for a valid user to remember (by using cues), while simultaneously more difficult for an attacker to guess, even in the case where that attacker might be looking over the user's shoulder. A user will initially register an image and a question/answer pair about this image when setting up an account. At authentication time, the user will be presented with a set of images (one of which may be the user's registered image) and question (which serves as a memory cue to the user) and will be asked to provide the registered answer. By selecting the correct image and providing the correct answer to the given question, the user can prove their identity. Because this requires two secrets to authenticate, it is immediately compatible with the idea of two-factor authentication, where a user could be required to answer the question via one method (e.g., a mobile phone) and select an image via another (e.g., a web browser).

### BACKGROUND OF THE INVENTION

### Field of the Invention

The present invention generally relates to personal authentication employing Visual Question Authentication Protocol (VQAP) using a combination of pictures and text passwords and, more particularly, to a Collaborative Context-aware Visual Question Answering (C2VQA) system to produce a text answer given an image and a text-based question about that image in the presence of corrupt, incomplete, or irrelevant data for purposes of authenticating a user seeking access to protected resources.

### Background Description

Some user interfaces (UI) exist that require interaction with humans in a meaningful way. One such UI is the “I'm not a robot” or CAPTCHA example where a user first checks a “I'm not a robot” box and then is presented with a matrix of images and asked to select those images that meet a certain characteristic. This is a verification system used to verify that a “user” is in fact not an automated script attempting to access some website. A user in this context is not individually known to the verification system and no secret information is stored or used to validate the user's unique identity. Such systems are not relevant to the present invention.

The present invention is directed to an authentication system wherein a user is presented with a challenge to gain access to protected resources and must validate their unique identity against the information that the system has about the user. The resources may be located in a physical location, an on-line database, cloud-storage backup, webmail, on-line banking, or other resources that require protection. Strong automatic authentication processes are necessary in an age where authentication attacks, in the form of website intrusion, phising and cybercrime in general are on the rise. Though a variety of approaches exist for authentication (including biometric methods), the majority are still split between text-based passwords and graphical methods that require a user to interact with images. At the heart of authentication is the validation of secret information that only the true user should know, such as a password in text-based systems. Text passwords, however, are a constant source of frustration for most users, as rules for creating secure combinations of characters, numbers and symbols conversely result in less-memorable passwords. People are being taught to adhere to complex, and often confusing rules for creating passwords that do not play well to the strengths of human memory. Security rules around text-based passwords are often coupled with additional restrictions that specify how often passwords must be changed.

Graphical or image-based authentication, on the other hand, require a user to interact with images in a meaningful way for purposes of authentication. One such system is Visual Question Answering (VQA) which involves the task of producing a text answer, given an image and a text-based question about that image. This approach requires understanding the meaning and intent of the question, looking at the image content, and then producing a response that is based on both current and previously acquired knowledge. Attempting to answer the given question when ignoring one or both of these inputs (such as guessing the correct answer) should most likely fail. Therefore, in order to be successful in such a task, models must take in multiple modalities of data (visual and text) and join them together in a meaningful way in a process called multimodal fusion.

Models that take advantage of such fusion are called multimodal models. The sources of information for training multimodal models are varied. Within the visual realm, there are images and videos, which can come from a number of different sources, such as cellphone recordings, surveillance cameras, television broadcasts, satellite imagery, or even medical images. Text sources are just as varied, including both structured data, such as ontologies like WordNet, and unstructured data, such as questions, answers, image captions, news posts, and even social media data. While this list is not exhaustive, it serves to show the variety of data sources that VQA involves. VQA itself has numerous variants that fall within the umbrella of multimodal models. Using video as the specific visual modality, the task is often referred to as Video Question Answering, which now must take into account the temporal aspect of questions that span time periods that require understanding in order to give a correct answer. When the task involves multiple, related questions and answers, it is referred to as Visual Dialog, which is a variant of VQA that must handle the temporal aspects of memory by recalling previous answers as a part of the context of answering the current question.

Each of these inputs, however, are possible points of failure. Given this, we pose the following overarching questions: What if the input to Visual Question Answering systems were incomplete or corrupted? What are the implications of handling such input and how can VQA systems be trained to relax their assumptions about the nature of their input? This query is not based in a fantastical stretch of the imagination or a contrived situation, but instead firmly rooted in the reality that humans navigate every day. Given that we live and act in the real world, humans face corrupted, incomplete, and irrelevant data constantly, whether it is a misunderstood direction on a written form (corrupted), a tangentially related query from a child (incomplete), or a coworker's question that “sidetracks” the current conversation (irrelevant).

### SUMMARY OF THE INVENTION

It is therefore an object of the present invention is to approach VQA using a collaborative and context-aware approach where the content of queries can be parsed to assess their relevance, if any, and iteratively refined for their ultimate resolution. The Collaborative Context-Aware Visual Question Answering (C2VQA) methodology according to the invention encompasses Convolutional Neural Networks (CNNs), Recurrent Neural Networks (RNNs) and deep learning, joint visual-text embedding, sequencing, and memory models to interpret the queries and best answer them.

We amend the task of VQA to describe the purpose of a Collaborative Context-Aware Visual Question Answering (C2VQA) system, namely to produce a text answer, given an image and a text-based question about that image in the presence of corrupt, incomplete, or irrelevant data. The C2VQA task is one that is more attuned to real-world scenarios and is more applicable to a larger set of applications than VQA alone.

More particularly, the invention is a system for improved personal authentication using a novel combination of pictures and text passwords that gets more secure over time as more users utilize the system. The invention increases the security of authentication by using methods that are easier for a valid user to remember (by using cues), while simultaneously more difficult for an attacker to guess, even in the case where that attacker might be looking over the user's shoulder. The basic idea is that a user will initially register an image and a question/answer pair about this image when setting up an account. At authentication time, the user will be presented with a set of images (one of which may be the user's registered image) and a question and will be asked to provide the registered answer. By selecting the correct image and providing the correct answer to the given question, the user can prove their identity. Research has demonstrated that images are far more memorable than text-based passwords, leading to less wasted effort resetting user passwords. Because this requires two secrets to authenticate the user, it is immediately compatible with the idea of two-factor authentication, where a user could be required to answer the question via one method (e.g., a mobile phone) and select an image via another (e.g., a web browser).

At the root of the invention is a better method for selecting the set of images to present to a user using a specialized machine learning model, the combination of text and image passwords, and some other login scenarios that help to thwart attackers. This methodology does not suffer from security flaws that exist with other authentication methods, such as those based on selecting faces as a password and those that use text-based passwords.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a block diagram of the overall system according to the invention;

FIG. 2 is a flow diagram illustrating the logic of the user registration process implemented by the system shown in FIG. 1;

FIG. 3 is a flow diagram illustrating the logic of background processes performed by the system shown in FIG. 1 after a user has successfully registered with the system;

FIG. 4 is a flow diagram illustrating the logic of the authentication process for access to a protected resource implemented by the system shown in FIG. 1;

FIG. 5 is a diagram illustrating example authentication scenarios; and

FIG. 6 is a block diagram of the base architecture of C2VQA.

### DETAILED DESCRIPTION THE INVENTION

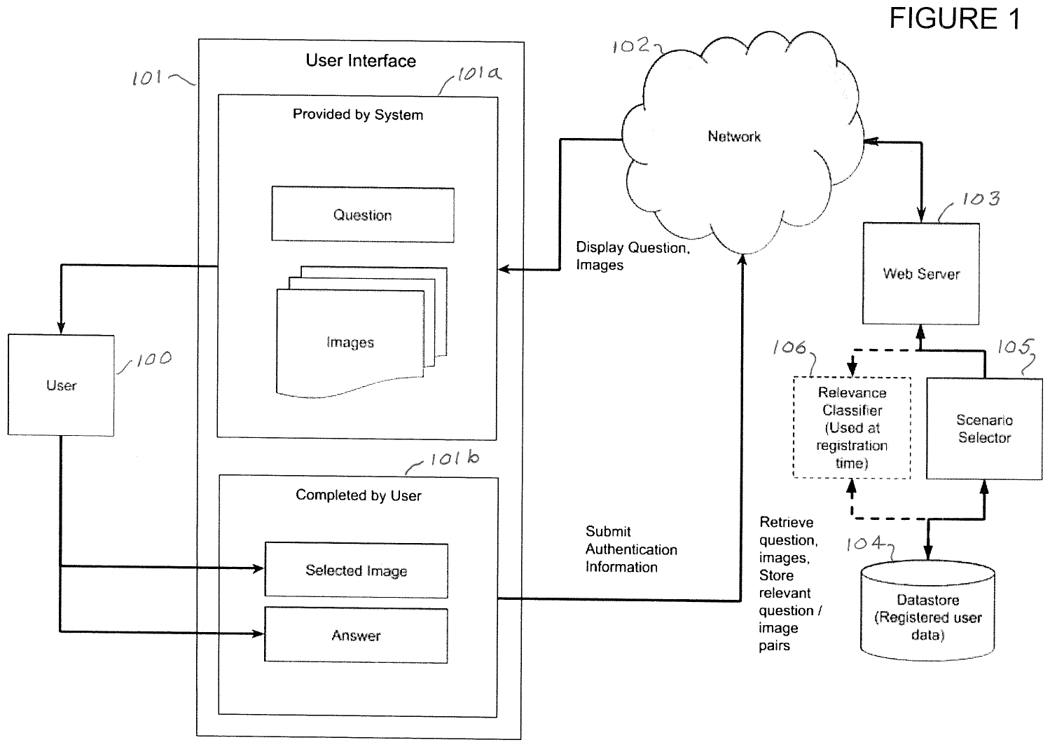

Referring now to the drawings, and more particularly to FIG. 1, there is shown a block diagram of the overall system according to invention. Here the user 100 interacts with a user interface (UI) 102. This UI 102, while illustrated in a single block, may in practice be implemented by multiple user interfaces, schematically shown here as 101a and 101b. The UI 101a is provided by the system and in the authentication process presents multiple images to the user with a text-based question. In the UI 101b, the user responds by selecting and image and providing an answer to the question. The system could be implemented by a local computer, but it is contemplated that in a typical scenario the UI 101 would communicate via a network 102, such as the Internet or a cloud-based network, to a Web server 103. The Web server 103 generates the text-based question and images that are displayed on the UI 101a. The authentication information generated at the UI 101b are communicated via the network 102 to the Web server 103. The Web server 103 accesses a data store 104 of registered user data through a scenario selector 105 to provide the question and images displayed by UI 101a. The user data in the data store 104 is generated at registration time via the relevance classifier 106.

The scenario selector component 105 can take the form of any number of implementations. For example, this could be as simple as random selection or as complex as a deterministic trigger that responds to advanced persistent threats (APTs), such as large scale spoofing attacks. In addition, this component could be configured to present multiple scenarios, while being mindful of the human capacity for remembering multiple graphical passwords. This component then passes along a question and a set of images to be scored by the relevance classifier 106, which splits the relevant from the irrelevant images before passing the set onto the user for authentication. The reasoning behind having such a component, and for having multiple authentication challenge scenarios, is flexibility, security, and adaptability.

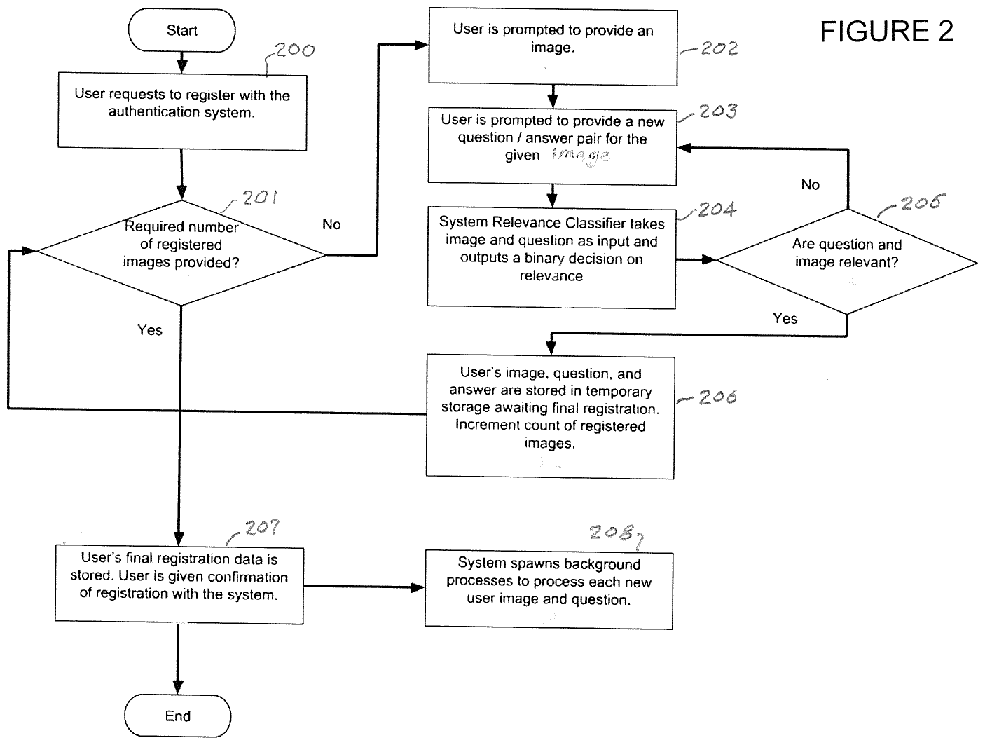

FIG. 2 is a flow diagram illustrating the logic of the user registration process implemented by the system shown in FIG. 1. The registration process begins at function block 200 where the user requests to register with the authentication system. A test is made at decision block 201 to determine if the required number of registered images have been provided. Initially and for a predetermined number of required images, the output of decision block 201 goes to function block 202 where the user is prompted to provide an image. Then, in function block 203, the user is prompted to provide a new question/answer pair for the input image. The system relevance classifier 106 (FIG. 1) takes the image and question as input and outputs a binary decision on relevance in function block 204. Based on the output of the relevance classifier, a determination is made in decision block 205 as to whether the question and image are relevant. If not, a return is made to function block 203 where the user is again prompted to provide a new question/answer pair for the given image; otherwise, the process goes to function block 206 where the user's image, question and answer are stored in temporary storage awaiting final registration. At this point, the count of registered images is incremented by one and the process returns to decision block 201. The process continues through steps 202 to 206 until the required number of registered images have been provided by the user at which time the process goes to function block 207 where the user's final registration data is stored. The user is given confirmation of the registration with the system at the successful conclusion of the registration process. At this point, the system spawns background processes to process each new user image and question in function block 208.

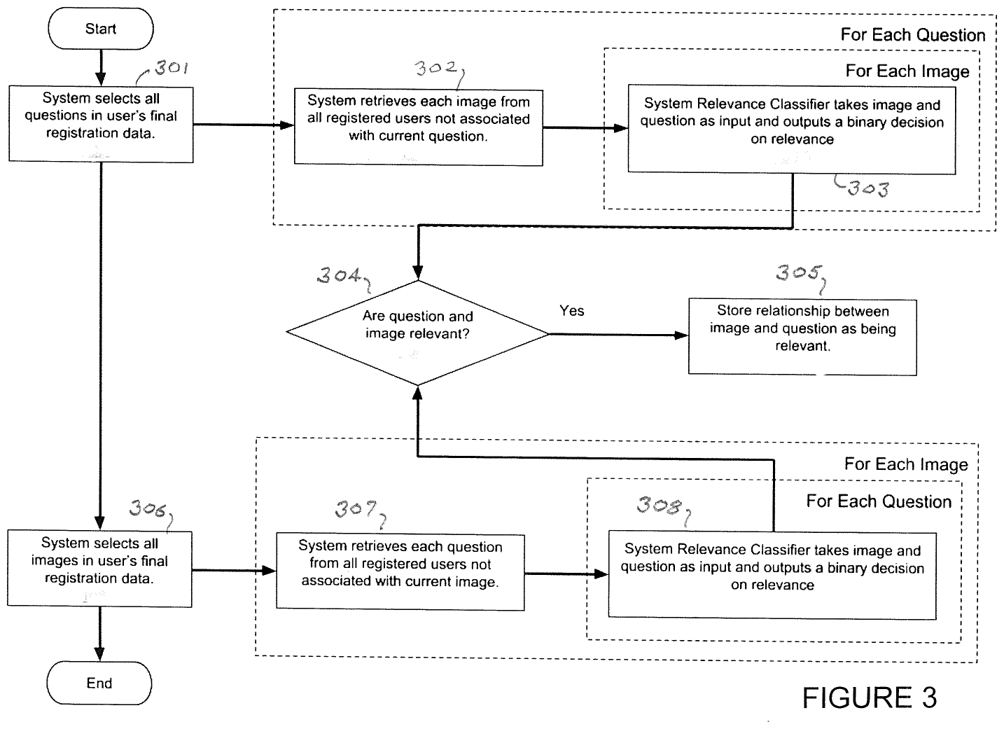

Next, the background processes of block 208 are shown in FIG. 3. Here, the system accesses all the question in the user's final registered data in the data store 104 (FIG. 1) in function block 301. For each question, the system retrieves each image from all registered users not associated with the current question in function block 302. The system relevance classifier 106 (FIG. 1) takes the image and the question as input and outputs a binary decision on relevance in function block 303. This output goes to decision block 304 where a determination is made as to whether the question and the image are relevant. If so, the relationship between the image and question is stored as being relevant in function block 305. This process is repeated for each question in the user's final registration data. In addition, the system also selects at function block 306 all images in the user's final registration data. Then, the system retrieves each question from all registered users not associated with the current image at function block 307. The system relevance classifier 106 takes the image and the question as input and outputs a binary decision on relevance in function block 308, and the process goes to decision block 304 where a determination is made as to whether the question and the image are relevant. If so, the relationship between the image and question is stored as being relevant in function block 305. This process is repeated for each image in the user's final registration data.

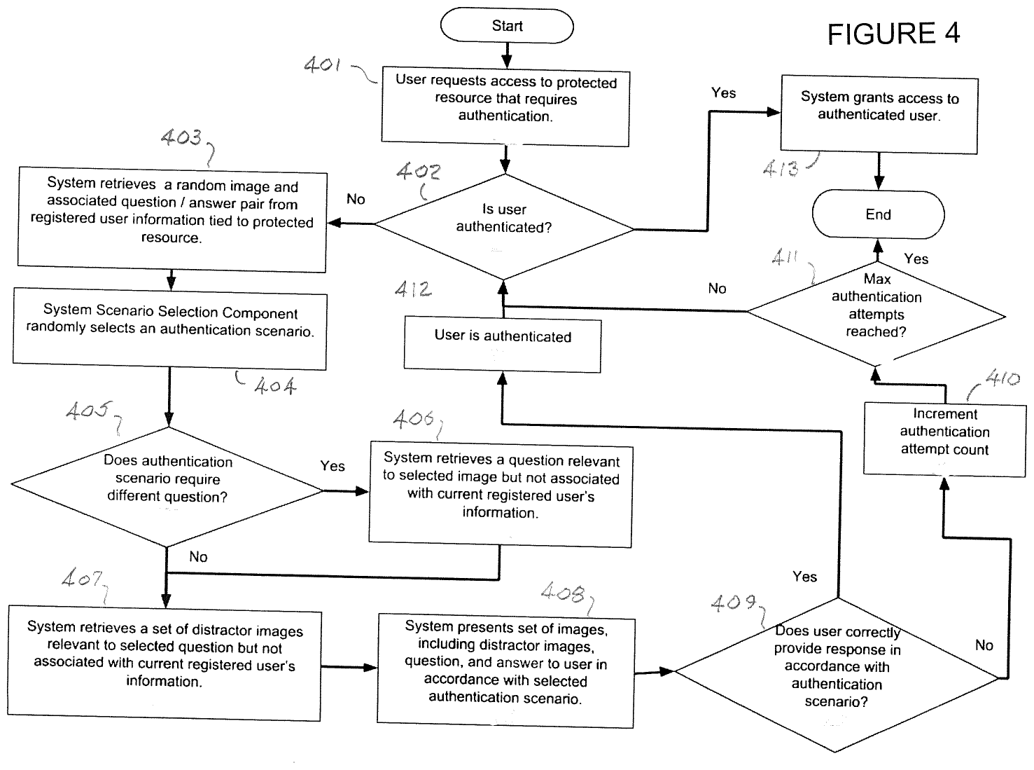

Once the registration process has been successfully completed for a user, the user can be authenticated for access to a protected resource. The process starts in function block 401 of FIG. 4 where the user requests access to the protected resource. A determination is made in decision block 402 as to whether the user is authenticated and, if not, the process goes to function block 403 where the system retrieves a random image and associated question/answer pair from registered user information tied to the protected resource. This is done in function block 404 where the system scenario selection component 105 (FIG. 1) randomly selects and authentication scenario. A determination is made in decision block 405 as to whether the authentication scenario requires a different question. If so, the system retrieves a question relevant to the selected image but not associated with the current registered user's information in function block 406. If the authentication scenario does not require a different question or when a question relevant to a selected image is retrieved in function block 406, the process goes to function block 407 where the system retrieves a set of distract or images relevant to the selected question but not associated with the current registered user's information. Then, in function block 408 the system presents a set of images, including distract or images, and the question and answer prompting the user to respond inn accordance with the selected authentication scenario. A determination is made in decision block 409 as to whether the user correctly provided a response in accordance with the authentication scenario. If not, the authentication attempt is incremented one count in function block 410, and a determination is made in decision block 411 whether the maximum authentication attempts has been reached. If so, the authentication process ends locking the user out of the system. Returning to decision block 409, if the user correctly provides a response in accordance with the authentication scenario, the user is authenticated and the process goes to function block 412. The determination in decision block 402 is therefore affirmative and the process goes to function block 413 where the system grants access to the authenticated user.

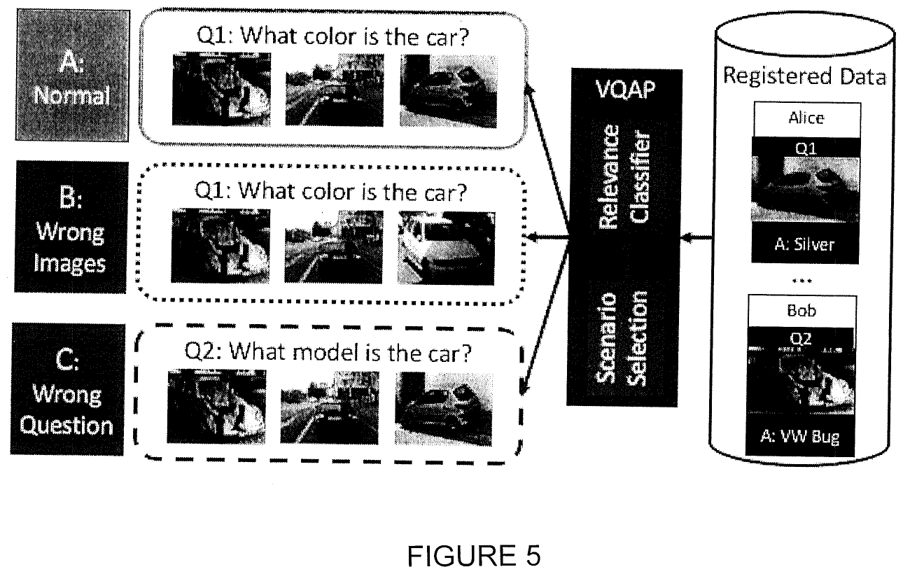

FIG. 5 provides authentication examples. For the purposes of these examples, it is assumed that the user is Alice and that Alice has already registered correctly with the system and is attempting to authenticate. See the process of FIG. 4. For this, the system will select an authentication scenario (steps 401 to 404). It should be noted that the authentication scenarios illustrated in FIG. 5 are illustrative, as VQAP is extensible to include future scenarios. For a “normal” authentication scenario A, Alice would proceed through steps 405, 407 and 408 in FIG. 4. In this case, one of the images is drawn from the set of registered images. In addition, the given question is the registered question for that image and the desired answer is the registered answer. At this point, Alice will be required, as per the authentication scenario, to select her registered image and provide her registered answer to the given question, which is her registered question. To authenticate successfully in this case, Alice must select her image (the right most image) from the distractor images, and provide “silver” as the answer to the given question “What color is the car?”, as these match her registered data. Upon doing so, Alice becomes authenticated (steps 409,412, 402, and 413). Any variation from these elements by a user would result in a failed authentication attempt, including the selection of an image that is not the registered image or providing an answer that does not match the registered answer. In this example, this would correspond to Alice either selecting the middle or leftmost image as her selected image or by answering the question incorrectly, or both. Because this scenario contains a registered image, registered question and expects the registered answer, it is considered a “normal scenario”.

Now, assume an attacker attempts to authenticate as Alice. The attacker will be presented with steps 401 to 404, as before; however, we shall now assume that the system selects authentication scenario B, wrong images, an example of an active authentication scenario to aggressively guard against advanced persistent threats. In this case, the question is Alice's registered question, but all the images provided to the attacker are distractor images (steps 405 to 408) that are deemed relevant to the given question. In order to properly authenticate with this scenario, the attacker must select any image but provide the answer that only Alice should know, which is that none of the given images are her registered image. If the attacker fails to provide this answer, they would proceed through steps 409 to 411 and start again at step 402 until the maximum number of authentication attempts is reached and they are not provided access to the system. Similarly, for scenario C, wrong question, one of the images is Alice's registered image, but this question is not Alice's registered question for her registered image, and only Alice would know this. In the example illustrated, the question “What model is the car?” is a registered question, but it is Bob's registered question, not Alice's. Alice could authenticate by selecting her registered image and communicate the fact that this is not her registered question.

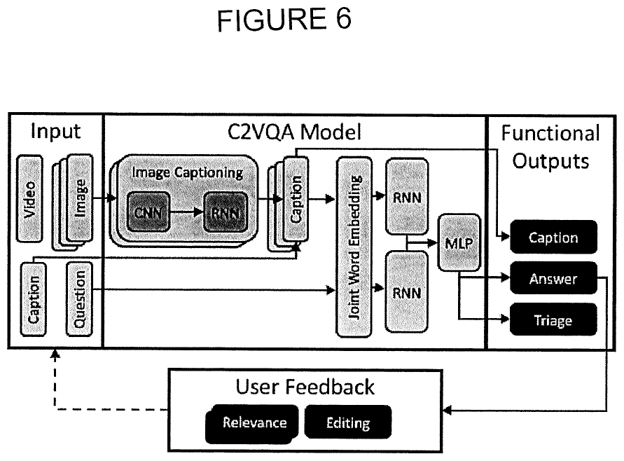

The overall architecture and description of the invention to fulfill the C2VQA task will now be described. The design and components of the system are given in FIG. 6. On the far left of the diagram, we see the inputs that can be provided to the system. Depending on the need, either videos or images can be used as visual input, though in most practical scenarios videos are subsequently parsed into a series of image frames. The text input to the system is a question which is parsed into tokens and run through a word-embedding layer. This layer is responsible for turning tokens into dense word-vector representations which can be subsequently used by later layers.

The visual data is then fed into one or more image-captioning models The generated captions are each tokenized and passed through the same word embedding as the question in order to generate word vector representations. Each of these models has the option of either outputting single image descriptions, which cover the entire image with a single sentence, or dense image captions, which cover parts of the image, referred to as image regions. Again, depending on the task, one or both types of captioning models could be used. In practical implementations it was found that different models (both single and dense) that were trained on different datasets could provide a benefit. Because captioning models describe visual content through the lens of the data that it was trained with, including the vocabulary of that dataset, this part of the architecture provides a great deal of flexibility to a C2VQA system. For example, if a new task required knowledge about fine-grained clothing or hair-styles, this knowledge could be gained by substituting a pre-trained image captioning model that was trained to describe images of people in this way. Each captioning model contains within it, at a minimum, a visual model, such as Convolutional Neural Networks (CNNs), and word-generation components, such as an Recurrent Neural Networks (RNNs). If this architecture is treated as an end-to-end system, then such models would be fine-tuned as a part of the overall task. We purposefully did not use the end-to-end interpretation of the architecture, as a part of the goal of our design was to highlight how existing pre-trained components could be used in novel ways. Past this point, we describe a general and high-level process of learning that occurs about the separate channels of input, the image captions and the question. While the specifics are different for each later implementation, each sequence of input is encoded by some type of a RNN, which is responsible for learning the important items in each data sequence.

In order for the system to leverage all of the input data, some combination of the two types of data (images, via image captions, and question) is required. This combination of RNN outputs can be done in different ways. In some implementations, we favored “late fusion”, or the idea that the caption and question should be joined into a single feature representation at the latest possible layer. Other implementations utilized an earlier fusion, or even multiple layers of fusion, especially with dense captions that could be individually merged with the input question in different ways.

The block in FIG. 6 labeled MLP represents the final neural network that uses the previous layers as features and is responsible for generating the desired output. The outputs on the far right are notional, meaning that the exact same model architecture was not necessarily used in actual implementations to output both caption, relevance, triage, and edits at the same time. However, many implementations did train a model for one task, such as relevance, and reused this model as ranking model for a different task, such as triage.

At the root, it is necessary to point out that we are dealing with concepts from artificial intelligence, and most notably, Computer Vision (CV) and Natural Language Processing (NLP). As noted earlier, CNNs are a core component of the system, and owe lineage to both the areas of CV and machine learning. Likewise, NLP word vectorization techniques, such as Word2Vec, rely on machine learning to adapt to a given dataset. When combined with RNNs, these components, which are usable in both the CV and NLP domains, form the central parts of a Visual Question Answering (VQA) system.

Extending this to the base C2VQA system requires the addition of relevance and editing as new types of answers that the system can conceptually give back to the user in order to better work with them to achieve the current goal. We model relevance as a multi-class classification problem, where a single word in the question can be classified as irrelevant or the entire question can be classified as relevant. For the second aspect, triage, we use pre-trained models from the relevance task to demonstrate the filtering of irrelevant from relevant images based on the question.

VQAP is a cross-over between a graphical recognition-based system and a text-based cued-recall system. In order to use VQAP, a user is required to register three types of data: images, questions, and answers. A user may register multiple images, and a single image may be associated with one or more text-based questions, and each question must be associated with a single text-based answer. Each of these questions must be relevant with regard to their associated image, which is verified by using the relevance classifier. At registration time, when a user associates a question with a registered image as an authentication pair, the relevance classifier is given both of these items as input in order to output a classification of relevant or irrelevant. If the question/image pair is deemed irrelevant, then the user is prompted to alter the question or to select a different image. This ensures that a good authentication pair is selected and simultaneously begins to give VQAP the concept of “password strength”, which can easily be expanded on to more complex feedback. For instance, VQAP could also notify a user that images they are registering are already used by another user (which may not be an issue) or are too distinct from other images in the system (which could leave the user vulnerable if not enough similar distractors can be found).

While the invention has been described in terms of a single preferred embodiment, those skilled in the art will recognize that the invention can be practiced with modification within the spirit and scope of the appended claims.

1. A collaborative context-aware visual question answering authentication system comprising:
a user terminal serving as an application client for providing a user interface that displays a context-aware visual question to a user seeking authentication;
a server communicating with the user terminal by providing the user interface and receiving input from the user;
the server including
a persistent storage mechanism storing user registered data, user registered data consisting of at least one image, one or more text-based questions associated with each image and text-based answers to the questions, wherein each text-based question is associated with a single text-based answer;
a relevance classifier implemented as a machine learning-based classification model in a neural network which uses a combination of shallow image captioning and dense image captioning as a measure of relevance and selects distractor images from registered user images for purposes of authentication;
a scenario selection component which passes along a question and a set of images to the relevance classifier, the relevance classifier splitting relevant from irrelevant images before passing the set of images to the user terminal to prompt a user to answer a text-based question for purposes of authenticating the user;
wherein the user terminal receives a user input in response to the prompt and passes the user input to the server which provides user authentication or not depending on the user's input.

2. The collaborative context-aware visual question answering authentication system recited in claim 1, wherein the scenario selection component randomly selects an authentication scenario from images and question and answer pairs stored in the persistent storage mechanism, the authentication scenario comprising multiple images some or all of which are distractor images, the authentication scenario further comprising a question which may or may not be associated with one of the images, and wherein the user seeking authentication is prompted to select an image and an answer.

3. The collaborative context-aware visual question answering authentication system recited in claim 2, wherein a selected authentication scenario includes an image registered by the user seeking authentication and a question also registered by the user, a correct response to the prompt being selection of the registered image and providing an answer corresponding to the registered question.

4. The collaborative context-aware visual question answering authentication system recited in claim 2, wherein a selected authentication scenario includes only distractor images and no image registered by the user seeking authentication and a question by the user, a correct response to the prompt being selection of an registered image and providing an answer indicating that none of the images are the registered image of the user.

5. The collaborative context-aware visual question answering authentication system recited in claim 2, wherein a selected authentication scenario includes an image registered by the user seeking authentication and a question not registered by the user, a correct response to the prompt being selection of the registered image and providing an answer indicating that question is not the registered question corresponding to the selected image.
